(19) United States
(12) Patent Application Publication
(10) Pub. No.: US 2006/0249569 A1
(43) Pub. Date: Nov. 9, 2006

(54) Monetary card with programmable customer identification code

(75) Inventor: Chitra Jain, Glen Allen, VA (US)

Correspondence Address: BAKER BOTTS L.L.P., 2001 ROSS AVENUE, SUITE 600, DALLAS, TX, 75201-2980, US

(73) Assignee: Capital One Financial Corporation

(21) Appl. No.: 11/121,146

(22) Filed: May 3, 2005

(51) Int. Cl. G06K 5/00; G06Q 40/00

(52) U.S. Cl. 235/380; 705/44

(57) ABSTRACT

According to one embodiment, a method for using a monetary card is provided. A customer identification code for a card may be selected by a customer. The card may include a storage system that stores a monetary value. The selected customer identification code may also be stored in the storage system. The card may be activated for usage. The card may be received from the customer for a purchase, and the customer identification code may be read from the storage system. A code may be received from the customer and compared with the customer identification code read from the storage system. If the code received from the customer matches the customer identification code, the monetary value stored by the storage system may be reduced by an amount associated with the purchase.

### TECHNICAL FIELD OF THE INVENTION

This invention relates in general to monetary cards and, more particularly, to a monetary card having a programmable customer identification code, such as a personal identification number (PIN), for example.

### BACKGROUND OF THE INVENTION

Stored value cards are one of the fastest growing products in the financial industry. Stored value cards include merchant gift cards, prepaid telephone cards, payroll cards, government benefit cards, and prepaid debit cards used to purchase goods or services. Stored value cards often provide consumers a more effective means of accessing funds and making financial transactions than cash or credit cards, and such stored value cards come with a vast array of features, fee structures and levels of consumer protections.

Typically, stored value cards use magnetic stripe technology to store information about funds that have been prepaid to the card. There are two main categories of stored value cards in the marketplace. The first type of stored value cards are single-purpose or ‘closed-loop’ cards. Example of single-purpose cards include gift cards, which can only be used to purchase goods at particular retailers, and prepaid telephone cards, which can only be used to make telephone calls. The second type of stored value cards are multipurpose or ‘open-loop’ cards, which can be used to make debit transactions at a wide variety of retail locations, as well as for other purposes, such as receiving direct deposits and withdrawing cash from ATMs, for example.

Consumers may obtain stored value cards in a variety of ways. For example, they may obtain a payroll card from an employer, an electronic benefit card from a government agency, or a gift card from a retail store. Typically, a consumer would apply for a general spending multipurpose card by telephone or online, although these cards may be increasingly offered at check-cashing outlets, money transfer company locations, and retail stores.

Some stored value cards are reloadable. In particular, reloadable multipurpose cards most closely resemble traditional deposit account debit cards in functionality. Consumers not only can use these cards to make payments to a wide variety of merchants and service providers but also can reload them with additional funds. Such cards can be reloaded in various ways, such as by direct deposit, money wire transfer, money order, or cash presentment at designated retail locations such as convenience stores, for example.

### SUMMARY OF THE INVENTION

In accordance with the present invention, systems and methods for providing and managing a monetary card having a programmable customer identification code, such as a personal identification number (PIN), for example.

According to one embodiment, a method for providing and managing a monetary card having a programmable customer identification code is provided. A customer identification code selected by a first customer for a card is receiving from the first customer. The card includes a storage system that stores a monetary value. The customer identification code selected by the first customer is stored in the storage system, and the card is activated for usage. The card is received from the first customer for a purchase. The customer identification code is read from the storage system, a code is received from the first customer, and a determination of whether the code received from the first customer matches the customer identification code is made. If the code received from the first customer matches the customer identification code, the monetary value stored by the storage system may be reduced by an amount associated with the purchase.

According to another embodiment, a system for providing and managing a monetary card having a programmable customer identification code includes a card setup module, an activation module, and a transaction module. The card setup module may be operable to receive from a first customer a customer identification code selected by the first customer for a card, the card including a storage system that stores a monetary value, and store the customer identification code selected by the first customer in the storage system. The activation module may be operable to activate the card for usage. The transaction module may be operable to receive the card from the first customer for a purchase, read the customer identification code from the storage system, receive a code from the first customer, determine whether the code received from the first customer matches the customer identification code, and if the code received from the first customer matches the customer identification code, reduce the monetary value stored by the storage system by an amount associated with the purchase.

According to another embodiment, a method for providing and managing a monetary card having a programmable customer identification code is provided. A customer identification code for a card is selected by a first customer, the card having a card customer identification code stored on the card. The customer identification code and the card customer identification code may be communicated via a communications network to a storage system such that the customer identification code is stored as card data associated with the card, the card data also including a monetary value associated with the card. The card may be activated for usage. When the card is later received from the first customer for a purchase, the card customer identification code may be read from the card and used to retrieve from the storage system the customer identification code associated with the card. A code may be from the first customer, and a determination of whether the code received from the first customer matches the customer identification code retrieved from the storage system may be made. If the code received from the first customer matches the customer identification code retrieved from the storage system, a command may be communicated to the storage system to reduce the monetary value associated with the card by an amount associated with the purchase.

According to another embodiment, a system for providing and managing a monetary card having a programmable customer identification code includes a card setup module, an activation module, and a transaction module. The card setup module may be operable to receive from a first customer a customer identification code selected for a card by the first customer, the card having a card customer identification code stored on the card. The card setup module may also be operable to communicate the customer identification code and the card customer identification code via a communications network to a storage system such that the customer identification code is stored as card data associated with the card, the card data also including a monetary value associated with the card. The activation module may be operable to activate the card for usage. The transaction module may be operable to receive the card from the first customer for a purchase, read the card customer identification code from the card, and use the card customer identification code read from the card to retrieve the customer identification code associated with the card from the storage system. The transaction module may also be operable to receive a code from the first customer, determine whether the code received from the first customer matches the customer identification code retrieved from the storage system, and if the code received from the first customer matches the customer identification code retrieved from the storage system, communicate to the storage system a command to reduce the monetary value associated with the card by an amount associated with the purchase.

According to still another embodiment, a card for making purchases includes a storage system operable to store a monetary value for the card and a customer identification code selected by a first customer for a card. The card may be operable to communicate with an activation module in order to activate the card for usage. The card may be used to make a purchase by the customer identification code being retrieved from the storage system by a card interface system, the retrieved customer identification code being compared with a code received from the first customer, and if the code received from the first customer matches the customer identification code, the monetary value stored by the storage system being reduced by an amount associated with the purchase.

According to yet another embodiment, a computerized system for providing and managing a monetary card having a programmable customer identification code includes a computer system having a processor, and a computer readable medium coupled to the computer system. The computer readable medium includes a program operable, when executed by the processor, to receive from a first customer an customer identification code selected by the first customer for a card, the card including a storage system that stores a monetary value, store the customer identification code selected by the first customer in the storage system, and activate the card for usage. In association with an attempted purchase using the card, the program may be further operable, when executed by the processor, to read the customer identification code from the storage system, receive a code from the first customer, determine whether the code received from the first customer matches the customer identification code, and if the code received from the first customer matches the customer identification code, reduce the monetary value stored by the storage system by an amount associated with the purchase.

Various embodiments of the present invention may benefit from numerous advantages. It should be noted that one or more embodiments may benefit from some, none, or all of the advantages discussed below.

One advantage of the invention is that monetary cards, such as stored value cards or smart cards, such as gift certificate cards or store cards, for example, may include a programmable customer identification code stored in memory on the cards. The programmable customer identification code may provide a level of security to a card, such as preventing unauthorized transactions using the card. For example, in some embodiments, in order to make purchases using the card, a customer (e.g. the card holder) must provide a code matching the customer identification code stored on the card, such as by verbally communicating the code to a cashier or other personnel associated with the relevant merchant or by entering the code into a customer interface, such as a card interface device, for example. Thus, an unauthorized user may be prevented from making purchases using the card.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for providing, activating, and using a monetary card to make purchases in accordance with an embodiment of the invention; and

FIG. 2 illustrates an example method for providing, activating, and using a monetary card to make purchases in accordance with an embodiment of the invention

### DETAILED DESCRIPTION OF THE DRAWINGS

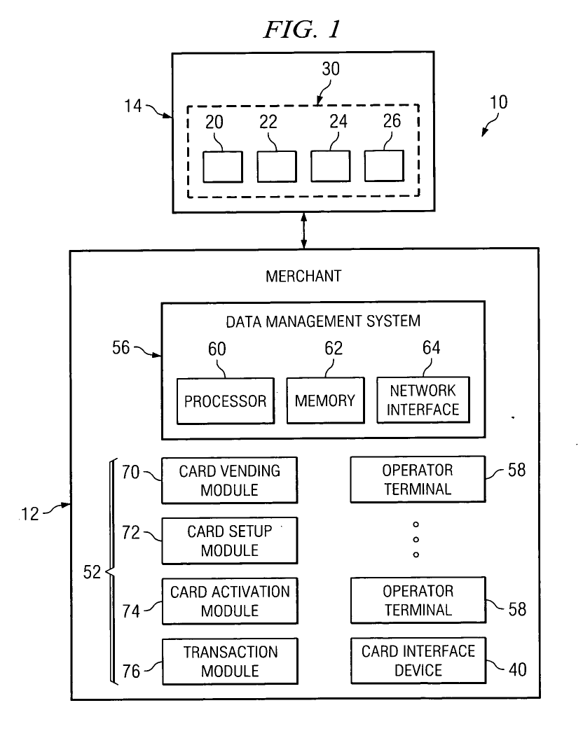

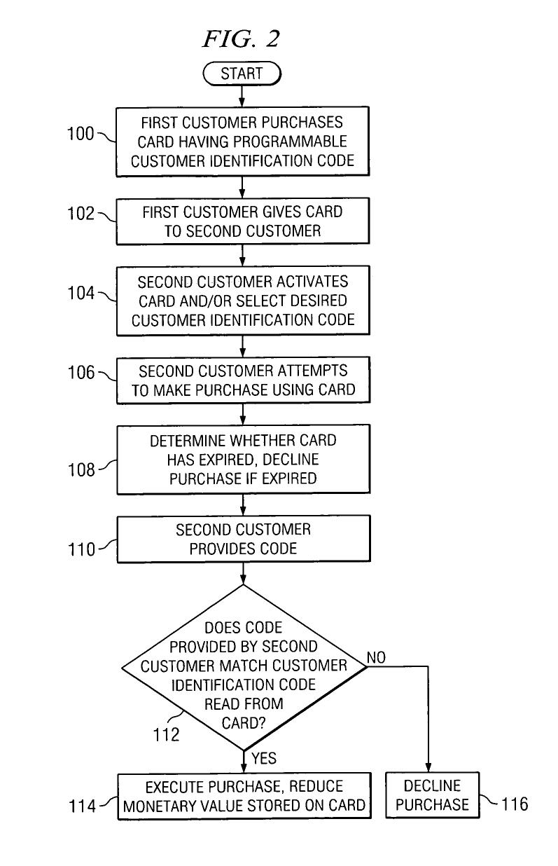

Example embodiments of the present invention and their advantages are best understood by referring now to FIGS. 1 and 2 of the drawings, in which like numerals refer to like parts.

FIG. 1 illustrates an example system 10 for providing, activating, and using a monetary card to make purchases in accordance with an embodiment of the invention. System 10 may include a merchant 12 and a plurality of monetary cards 14 provided by merchant 12.

Generally, a merchant 12 sells or otherwise provides cards 14 to customers that may be used to make purchases associated with that merchant 12 or other merchants 12. A card 14 may be any card having one or more memory devices 30 provided on the card 14 that can store various data, such as a monetary value 20, a customer identification code 22, a card identification code 24 and/or an expiration date 26, as discussed below. For example, a card 14 may be a stored value cards or a smart card, such as a gift certificate card, a store card, a payroll card, a government benefits card, a telephone calling card, or a mall card that includes memory for storing various data related tot the card 14.

A merchant 12 may sell cards 14 that may be used to purchase goods or services from that merchant 12 or other merchants 12. Cards 14 may be stored value cards or smart cards, such as gift certificate cards or store cards, for example, that include memory for storing the current monetary value of each card 14. Cards 14 may have a particular monetary value 20 which may be stored in a memory device 30 provided on the cards 14. As used herein, the phrase “provided on card 14” with reference to memory devices 30 or other devices (e.g., a processor) describes any physical coupling of such devices to a card 14, such as the device being provided on a surface of the card 14, located at least partially within the card 14, or otherwise physically coupled to the card 14.

The monetary value 20 may be pre-loaded onto a card 14, or a card 14 may be loaded with a monetary value 20 selected and paid by a customer. For example, merchant 12 may sell gift certificate cards 14 which are pre-loaded with various monetary values, such as $20, $50, and $100 gift certificate cards 14. Alternatively, merchant 12 may sell an unloaded gift certificate card 14, which may be loaded with any amount desired by the customer purchasing the card 14.

The customer identification code 22 stored on a card 14 may provide security to prevent the card 14 from being used by unauthorized persons. For example, in some embodiments, in order to make purchases using the card 14, a customer (e.g. the card holder) must provide a code matching the customer identification code 22 stored on the card, such as by verbally communicating the code to a cashier or other personnel associated with the relevant merchant 12 or by entering the code into a customer interface, such as a card interface device 40, for example. In some embodiments, the customer identification code 22 is similar to a PIN or other security code, and may be selected by the purchaser or owner of the card 14, or by the merchant 12. Each customer identification code 22 may include any number, combination and/or configuration of numbers, letters, symbols, characters, or any other data that may allow that customer identification code 22 to be identified and/or distinguished from other customer identification codes 22. The customer identification code 22 may be stored in a memory device 30 provided on the card 14, which may or may not be the same memory device 30 that stores the monetary value 20, card identification code 24 and/or expiration data 26 of the card 14.

The card identification code 24 stored on a card 14 may be used to identify the card 14 from other cards 14. In some embodiments, each card 14 has a unique identification code 24. Card identification code 24 may be stored in a memory device 30 on card 14, which may or may not be the same memory device or devices 30 that store the monetary value 20, customer identification code 22 and/or expiration date 26 on the card 14.

The expiration date 26 stored on a card 14 may indicate a date and/or time that the card 14 may expire, may also be stored in a memory device 30 on card 14, which may or may not be the same memory device or devices 30 that store the monetary value 20, customer identification code 22 and/or card identification code 24 on the card 14.

The monetary value 20, customer identification code 22, and/or expiration date 24 may be stored in the same memory device 30, in separate memory devices 30 of the same type, or in separate memory devices 30 of different types. Memory device or devices 30 on a card may include any device or devices suitable to store data, such as one or more magnetic stripes, transistors, RFID devices, and/or memory chips, such as random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), or flash memory, for example. Other electronic devices may also be stored on cards 14, such as a processor operable to process various data stored in memory device(s) 30, for example.

Customers who purchase cards 14 may use cards 14 themselves to make purchases, or purchase and give cards 14 to other customers, for example as a store-specific gift certificate. For example, a first customer may purchase a $50 gift certificate card 14 from merchant 12 which is loaded with a monetary value of $50. The first customer may then gift the $50 gift certificate card 14 to a second person as a gift. The second customer, or in other words the cardholder, may select an customer identification code 22, such as a PIN, for the card 14, which merchant 12 may then have stored in memory provided on the card 14. Merchant 12 may also activate the card 14 such that the cardholder may make transactions, such as purchases, using the card 14.

To make a purchase using the card 14, the cardholder presents the card 14 to a card interface device 40 provided by merchant 12. Card interface 40 may include any device or devices for reading information from and/or writing information to cards 14. For example, card interface 40 may be a credit card authorization interface, a smart card reader, a debit card reader, or a stored value card reader, for example. Card interface device 40 may be operable to read data from and/or write data to one or more types of memory devices 30 provided on cards 14. Card interface device 40 may interface with such memory devices 30 provided on cards 14 via physical contact or otherwise, such as via radio or electromagnetic waves, for example.

Card interface device 40 may read the current monetary value 20, customer identification code 22, card identification code 24 and/or expiration data 26 from memory device(s) 30 on card 14. The cardholder may then provide (or attempt to provide) a code matching the customer identification code 22, such as by speaking the code to the cashier or other personnel associated with the merchant 12 or by manually (e.g. by typing or keying) or otherwise entering the code into a customer interface, such as a card interface device 40, for example. The merchant 12 may then compare the customer identification code 22 read from the card 14 with the code provided by the cardholder. This comparison may be performed or at least facilitated by any suitable computerized system, such as card interface device 40 or any other computer system associated with or available to merchant 12. Alternatively, the cashier or other personnel associated with the merchant 12 may manually compare the customer identification code 22 read from the card 14 with the code provided by the cardholder. If the customer has provided the correct code, and if the current monetary value 20 read from the card 14 is sufficient for the purchase, merchant 12 may execute the purchase by reducing the current monetary value 20 stored in the memory of card 14 by the amount of the purchase.

Merchant 12 may include any entity suitable for selling or otherwise providing cards 14 to customers and/or accepting payment from cards 14 in exchange for various products or services. A merchant 12 may include a single entity (such as, for example, an individual store) or a number of entities (such as, for example, a chain of stores). A merchant 12 may include a seller or distributor that sells items produced by one or more otherwise unaffiliated producers. In addition or as an alternative, a merchant 12 may include a producer that sells one or more items it produces directly to customers using cards 14, bypassing distributors. Merchant 12 may include one or more outlets at one or more physical locations and may, in addition or as an alternative, include one or more call centers where phone orders are received from customers using cards 14, one or more websites or other virtual locations where electronic orders are received from customers using cards 14, and/or one or more warehouses (which may be owned by merchant 12 or owned by one or more entities separate from merchant 12 for which merchant 12 sells items to cardholders) where orders received from customers using cards 14 are filled. Although merchants 12 are described as selling items to customers using cards 14, the present invention, as described above, contemplates any suitable transactions between merchants 12 and customers using cards 14. As an example, a merchant 12 may rent one or more items to customers using cards 14. As another example, a merchant 12 may include an entity which provides services in exchange for payment from a customers using a card 14, such as a barber or auto mechanic, for example.

Merchant 12 may include a card management system 50 that provides various functionality with respect to cards 14, such as, for example, generating cards 14, selling cards 14 to customers, setting-up cards 14 (such as storing a monetary value and or PIN in the memory provided by cards 14, for example), activating cards 14 for use, enabling transactions (such as purchases, for example) using cards 14, providing security for such transactions, managing the monetary value stored on cards 14, and deactivating cards 14 (such as when a card 14 has expired, for example).

Card management system 16 may include a card interface device 40, a plurality of function modules 52, a data management system 56, and one or more operator terminals 58. The components of card management system 16 may be located at one or more sites and may be coupled to each other using one or more links, each of which may include, for example, some or all of a computer bus, local area networks (LANs), metropolitan area networks (MANs), wide area networks (WANs), portions of the Internet, a public switched telephone network (PSTN), any other appropriate wireline, optical, wireless, or other suitable communication link, or any combination of the preceding.

An operator terminal 58 may provide an operator, such as a cashier, manager, other employee, or other individual associated with merchant 12, with access to data management system 56 to obtain information from, exchange information with, manage, configure, or otherwise interact with data management system 56. Operator terminal 58 may include a computer system. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device. Operator terminal 58 may include or be partially or completely integrated with card interface device 40 and/or data management system 56. For example, an operator terminal 58 may be a combined cash register and card interface device 40 that includes data management system 56.

Data management system 56 may manage data associated with cards 14, which may in particular embodiments include creating, modifying, and deleting data files associated with cards 14. Additionally, data management system 56 may call one or more function modules 52 to provide particular functionality according to particular needs, as described more fully below. Data management system 56 may include a data processing unit 60, a memory unit 62, a network interface 64, and any other suitable components for managing data associated with cards 14. The components of data management system 56 may be supported by one or more computer systems at one or more sites. One or more components of data management system 56 may be separate from other components of data management system 56, and one or more suitable components of data management system 56 may, where appropriate, be incorporated into one or more other suitable components of data management system 56.

Data processing unit 60 may process data associated with cards 14, which may include executing software or coded instructions that may in particular embodiments be associated with the one or more function modules 52. Memory unit 62 may be coupled to data processing unit 60 and may include one or more suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors.

A function module 52 may provide particular functionality associated with handling cards 14, such as, for example, generating cards 14, selling cards 14 to customers, setting up cards 14, activating cards 14 for use, enabling transactions using cards 14, providing security, managing the monetary values 20 stored on cards 14, and/or deactivating cards 14, for example. A function module 52 may be called by data management system 56 to the particular functionality associated with the function module 52.

According to the embodiment shown in FIG. 1, function modules 52 may include a card vending module 70, a card setup module 72, a card activation module 74, and a transaction module 76. Like data management system 56, function modules 52 may be physically distributed such that each function module 52 or multiple instances of each function module 52 may be located in a different physical location geographically remote from each other, from data management system 56, or both. In addition, each function module 52 may be partially or completely integrated with other function modules 52 and/or with other components of card management system 16. For example, particular function modules 52 may include one or more operator terminals 58 such that at least a portion of the functionality of such function modules 52 is provided by human operators. Thus it should be understood that the functionality provided by each function module 52 may be completely automated, partially automated, or completely human-controlled.

Card vending module 70 may provide functionality associated with selling cards 14 to customers. For example, card vending module 70 may receive a payment for a card 14 from a customer and provide the card 14 to the customer. In some embodiments, card vending module 70 may also generate cards 14, which may include storing particular data in the memory device(s) 30 provided on each card 14. Card vending module 70 may provide cards 14 having various data pre-loaded on the cards 14, such as initial monetary value 20, a card identification code 24 and/or an expiration date 26 for the card 14.

Card setup module 72 may provide functionality associated with setting up cards 14. For example, card setup module 72 may be operable to write, or store, various data in memory device(s) on a card 14, including one or more of an initial monetary value 20, a customer identification code 22, a card identification code 24 and/or an expiration date 26 for the card 14. Some or all of such data may be stored on a card 14 before the card is sold to a customer, or during the purchase of the card 14. In some embodiments, a cashier or other personnel associated with a merchant 12 may interface with card setup module 72 in order to facilitate setting up a card 14 for a customer. In other embodiments, card setup module 72 may be completely or substantially automated, such that a customer may enter desired parameters for the card 14 (e.g., initial monetary value 20 and/or customer identification code 22) into an interface associated with card setup module 72, and card setup module 72 may automatically set up the card 14 for the customer according to such parameters.

For example, regarding the initial monetary value 20, card setup module 72 and card vending module 70 may cooperate such that card vending module 70 provides an unloaded card 14 (in other words, a card not yet having a stored monetary value 20) for sale, a customer purchases the card 14 by making a payment to merchant 12, and card setup module 72 is used to store a monetary value 20 in a memory device 30 provided on card 14 based on the payment received from the customer. The monetary value 20 that card setup module 72 stores on card 14 may be equal to the amount of the customer's payment. Alternatively, card setup module 72 may determine a different amount of monetary value 20 to load onto the card 14. For example, card setup module 72 may take a fee from the customer's payment and the monetary value 20 stored on the card 14 may thus be less than the payment by some predetermined amount. As another example, card setup module 72 may give a bonus as an incentive for purchasing the card 14 and the monetary value 20 stored on the card 14 may thus be greater than the payment by some predetermined amount.

As another example, regarding customer identification code 22, card setup module 72 and card vending module 70 may cooperate such that card vending module 70 provides a card 14 for sale, a customer purchases the card 14 by making a payment to merchant 12 and communicating a desired customer identification code 22 to card setup module 72 (e.g, by communicating the desired customer identification code 22 to a cashier, who enters the code into an interface, or by manually (e.g. by typing or keying) or otherwise entering the code into a customer interface, such as a card interface device 40, for example. Card setup module 72 may then write, or store, the customer's desired customer identification code 22 into a memory device 30 on the card 14. In some embodiments, a first customer may purchase a card from card vending module 70 at a merchant 12, transfer the card to a second customer (e.g., as a gift or otherwise), and the second customer may then visit the merchant 12 to having a customer identification code 22 selected by the second customer stored on the card 14 by card setup module 72 at the merchant 12.

Card activation module 74 may be generally operable to activate a card 14 for use. Card activation module 74 may be completely or partially integrated with card vending module 70 and/or card setup module 72. The card owner or holder, or a cashier or other personnel associated with a merchant 12, may interface with card activation module 74 in order to activate a purchased card. Card activation module 74 may read the card identification code 24 stored on the card 14 being activated and communicate the card identification code 24 to storage, such as memory unit 62, in order to create a record that the card 14 has been activated.

Transaction module 76 may be generally operable to manage transactions (or attempted transactions) made using a card 14. For example, transaction module may be operable to receive a card 14 a customer attempting to make a purchase, read the customer identification code 24 from the appropriate memory device 30 on the card 14, receive a code from the customer 14 (such as verbally or via a customer interface, such as a card interface device 40, for example), determine whether the code received from the customer matches the customer identification code 24, and if the code received from the first customer matches the customer identification code, reducing the monetary value 20 stored by in the memory device 30 by an amount associated with the purchase.

FIG. 2 illustrates an example method for providing, activating, and using a monetary card to make purchases in accordance with an embodiment of the invention. At step 100, a first customer may purchase a card 14 having a programmable customer identification code 22 from a merchant 12, e.g., from a card vending module 70 associated with merchant 12. The card 14 may have an initial monetary value 20, a card identification code 24 and/or an expiration date 26 stored in one or more memory devices 30 provided on the card 14. For example, the first customer may pay a cashier at the merchant 12 an amount equal to, more than, or less than the monetary value 20 stored on the card. Alternatively, the first customer may select a desired monetary value 20 for the card, which may then be stored on the card by vending module 70, which may or may not be facilitated by a cashier.

At step 102, the first customer may give the card 14 to a second customer, for example, as a gift. At step 104, the second customer may visit the merchant 12 to activate the card 14 and/or select a desired customer identification code 22 for the card 14. The second customer and/or cashier or other personnel associated with a merchant 12 may interface with card activation module 74 and card setup module 72 to activate the card 14 and store the second customer's desired customer identification code 22 on the card 14.

At step 106, the second customer may again visit merchant 12 and attempt to make a purchase using the card 14 (or may attempt to make a purchase using the card 14 during the same visit to merchant 12 discussed at step 104). The second customer may present the card to a card interface device 40, which may read various information stored in memory device(s) 30 on the card, such as the monetary value 20, customer identification code 22, card identification code 24 and/or expiration date 26 stored on the card 14.

At step 108, transaction module 76 may first determine whether the card 14 has expired based on the expiration date 26 read from the card 14 at step 106. If it is determined that the card is expired, transaction module 76 may alert the merchant 12 (e.g., the cashier), and the transaction may be denied.

At step 110, the second customer may then provide (or attempt to provide) a code matching the customer identification code 22 stored on the card 14, such as by speaking the code to the cashier or other personnel associated with merchant 12 or by manually (e.g. by typing or keying) or otherwise entering the code into a customer interface, such as a card interface device 40, for example. At step 112, transaction module 76 may then compare the customer identification code 22 read from the card 14 with the code provided by the second customer. As discussed above, this comparison may be performed or at least facilitated by the cashier or by any suitable computerized system, such as card interface device 40 or any other computer system associated with or available to merchant 12.

If it is determined at step 112 that the second customer provided the correct, and if the current monetary value 20 read from the card 14 is sufficient for the purchase, merchant 12 may execute the purchase at step 114 by reducing the current monetary value 20 stored in the memory of card 14 by the amount of the purchase. However, if it is determined at step 112 that the second customer provided an incorrect code, transaction module 76 may notify the merchant 12 (e.g., the cashier), and the merchant 12 may provide the second customer one or more chances to provide the correct code or may decline the purchase at step 116.

Modifications, additions, or omissions may be made to the method without departing from the scope of the invention. Additionally, steps may be performed in any suitable order without departing from the scope of the invention.

Although an embodiment of the invention and its advantages are described in detail, a person skilled in the art could make various alterations, additions, and omissions without departing from the spirit and scope of the present invention as defined by the appended claims.

What is claimed is:

1. A method, comprising:
receiving from a first customer a customer identification code selected by the first customer for a card, the card including a storage system that stores a monetary value;
storing the customer identification code selected by the first customer in the storage system;
activating the card for usage;
receiving the card from the first customer for a purchase;
reading the customer identification code from the storage system;
receiving a code from the first customer;
determining whether the code received from the first customer matches the customer identification code; and
if the code received from the first customer matches the customer identification code, reducing the monetary value stored by the storage system by an amount associated with the purchase.

2. The method of claim 1, further comprising:
receiving from a second customer associated with the first customer a payment for the card; and
providing the card to the second customer in exchange for the payment.

3. The method of claim 2, further comprising:
determining the monetary value to store in the storage system based at least on the amount of the payment; and
storing the determined monetary value in the storage system.

4. The method of claim 1, further comprising:
storing in the storage system an expiration date for the card;
reading the expiration date from the storage system;
determining whether the card has expired based on the expiration date; and
allowing the card to be used for the purchase only if it is determined that the card has not expired.

5. The method of claim 1, wherein activating the card for usage comprises:
reading first activation data from the card;
communicating the first activation data to an activation system via a communications network;
receiving second activation data from the activation system; and
activating the card using the received second activation data.

6. The method of claim 1, wherein the card is a stored value card.

7. The method of claim 1, wherein the card is a smart card.

8. The method of claim 1, wherein the storage system comprises a magnetic stripe.

9. The method of claim 1, wherein the storage system comprises transistors.

10. The method of claim 1, wherein the storage system comprises a memory and a microprocessor.

11. A system, comprising:
a card setup module operable to:
receive from a first customer a customer identification code selected by the first customer for a card, the card including a storage system that stores a monetary value; and
store the customer identification code selected by the first customer in the storage system;
an activation module operable to activate the card for usage; and
a transaction module operable to:
receive the card from the first customer for a purchase;
read the customer identification code from the storage system;
receive a code from the first customer;
determine whether the code received from the first customer matches the customer identification code; and
if the code received from the first customer matches the customer identification code, reducing the monetary value stored by the storage system by an amount associated with the purchase.

12. The system of claim 11, further comprising a card vending module operable to:
receive from a second customer associated with the first customer a payment for the card; and
provide the card to the second customer in exchange for the payment.

13. The system of claim 12, further comprising a card setup module operable to:
determine the monetary value to store in the storage system based at least on the amount of the payment; and
store the determined monetary value in the storage system.

14. The system of claim 11, wherein:
the activation module is operable to store in the storage system an expiration date for the card; and
the transaction module is further operable to:
read the expiration date from the storage system;
determine whether the card has expired based on the expiration date; and
allow the card to be used for the purchase only if it is determined that the card has not expired.

15. The system of claim 11, wherein the activation module is operable to activate the card for usage at least by:
reading first activation data from the card;
communicating the first activation data to an activation system via a communications network;
receiving second activation data from the activation system; and
activating the card using the received second activation data.

16. The system of claim 11, wherein the card is a stored value card.

17. The system of claim 11, wherein the card is a smart card.

18. The system of claim 11, wherein the storage system comprises a magnetic stripe.

19. The system of claim 11, wherein the storage system comprises transistors.

20. The system of claim 11, wherein the storage system comprises a memory and a microprocessor.

21. A method, comprising:
receiving from a first customer a customer identification code selected by the first customer for a card, the card having a card customer identification code stored on the card;
communicating the customer identification code and the card customer identification code via a communications network to a storage system such that the customer identification code is stored as card data associated with the card, the card data including a monetary value associated with the card;
activating the card for usage;
receiving the card from the first customer for a purchase;
reading the card customer identification code from the card;
using the card customer identification code read from the card to retrieve the customer identification code associated with the card from the storage system;
receiving a code from the first customer;
determining whether the code received from the first customer matches the customer identification code retrieved from the storage system; and
if the code received from the first customer matches the customer identification code retrieved from the storage system, communicating to the storage system a command to reduce the monetary value associated with the card by an amount associated with the purchase.

22. The method of claim 21, further comprising:
receiving from a second customer associated with the first customer a payment for the card; and
providing the card to the second customer in exchange for the payment.

23. The method of claim 22, further comprising:
determining the monetary value associated with the card based at least on the amount of the payment; and
communicating the determined monetary value to the storage system for storage as card data associated with the card.

24. The method of claim 21, further comprising:
communicating an expiration date for the card to the storage system for storage as card data associated with the card;
retrieving the expiration date from the storage system;
determining whether the card has expired based on the retrieved expiration date; and
allowing the card to be used for the purchase only if it is determined that the card has not expired.

25. The method of claim 21, wherein activating the card for usage comprises:
reading first activation data from the card;
communicating the first activation data to the storage system;
receiving second activation data from the storage system; and
activating the card using the received second activation data.

26. The method of claim 21, wherein the card is a stored value card.

27. The method of claim 21, wherein the card is a smart card.

28. The method of claim 21, wherein the card customer identification code is stored on a magnetic stripe on the card.

29. The method of claim 21, wherein the card customer identification code is stored on a memory chip located on the card.

30. A system, comprising:
a card setup module operable to:
receive from a first customer a customer identification code selected by the first customer for a card, the card having a card customer identification code stored on the card; and
communicate the customer identification code and the card customer identification code via a communications network to a storage system such that the customer identification code is stored as card data associated with the card, the card data including a monetary value associated with the card;
an activation module operable to activate the card for usage; and
a transaction module operable to:
receive the card from the first customer for a purchase;
read the card customer identification code from the card;
use the card customer identification code read from the card to retrieve the customer identification code associated with the card from the storage system;
receive a code from the first customer;
determine whether the code received from the first customer matches the customer identification code retrieved from the storage system; and
if the code received from the first customer matches the customer identification code retrieved from the storage system, communicate to the storage system a command to reduce the monetary value associated with the card by an amount associated with the purchase.

31. The system of claim 30, further comprising a card vending module operable to:
receive from a second customer associated with the first customer a payment for the card; and
provide the card to the second customer in exchange for the payment.

32. The system of claim 22, further comprising a card setup module operable to:
determine the monetary value associated with the card based at least on the amount of the payment; and
communicate the determined monetary value to the storage system for storage as card data associated with the card.

33. The system of claim 30, wherein:
the activation module is operable to communicate an expiration date for the card to the storage system for storage as card data associated with the card; and
the transaction module is further operable to:
retrieve the expiration date from the storage system;
determine whether the card has expired based on the retrieved expiration date; and
allow the card to be used for the purchase only if it is determined that the card has not expired.

34. The system of claim 30, wherein the activation module is operable to activate the card for usage at least by:
reading first activation data from the card;
communicating the first activation data to the storage system;
receiving second activation data from the storage system; and
activating the card using the received second activation data.

35. The system of claim 30, wherein the card is a stored value card.

36. The system of claim 30, wherein the card is a smart card.

37. The system of claim 30, wherein the card customer identification code is stored on a magnetic stripe on the card.

38. The system of claim 30, wherein the card customer identification code is stored on a memory chip located on the card.

39. A card for making purchases, wherein:
the card comprises a storage system operable to store a monetary value for the card and a customer identification code selected by a first customer for a card;
the card is operable to communicate with an activation module in order to activate the card for usage; and
the card is operable to be used to make a purchase by:
the customer identification code being retrieved from the storage system by a card interface system;
the retrieved customer identification code being compared with a code received from the first customer; and
if the code received from the first customer matches the customer identification code, the monetary value stored by the storage system being reduced by an amount associated with the purchase.

40. A system, comprising:
a computer system having a processor; and
a computer readable medium coupled to the computer system, the computer readable medium comprising a program operable, when executed by the processor, to:
receive an customer identification code selected by a first customer for a card, the card including a storage system that stores a monetary value;
store the customer identification code selected by the first customer in the storage system;
activate the card for usage;
in association with an attempted purchase using the card, read the customer identification code from the storage system;
receive a code from the first customer;
determine whether the code received from the first customer matches the customer identification code; and
if the code received from the first customer matches the customer identification code, reducing the monetary value stored by the storage system by an amount associated with the purchase.
